(19) United States
(12) Patent Application Publication
(10) Pub. No.: US 2007/0019554 A1
(43) Pub. Date: Jan. 25, 2007

(54) Method and network nodes for path searching in a packet-oriented communication network

(76) Inventors: Gero Schollmeier, Gauting (DE); Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/561,681

(22) PCT Filed: Jun. 22, 2004
(86) PCT No.: PCT/EP04/51192

§ 371 Date: May 24, 2006

(30) Foreign Application Priority Data
Jun. 25, 2003 (DE) 103 28 620.9

(51) Int. Cl. H04J 3/14

(52) U.S. Cl. 370/238; 370/248

(57) ABSTRACT

In a network node of a packet-based communication network, comprising several network nodes, at least two path searches to a target network node are carried out in at least one network node, in series or parallel and the result of at least one of the path search methods is stored in the routing table.

### CROSS REFERENCE TO RELATED APPLICATIONS

This application is the US National Stage of International Application No. PCT/EP2004/051192, filed Jun. 22, 2004 and claims the benefit thereof. The International Application claims the benefits of German application No. 10328620.9 DE filed Jun. 25, 2003, both of the applications are incorporated by reference herein in their entirety.

### FIELD OF INVENTION

The invention relates to a method and network node for path searching in a packet-switching communication network.

### BACKGROUND OF INVENTION

Packet-switching communication networks, for example an internet protocol network or IP network, transmit electronic data in the form of packets or pulse frames from a source network node to a destination network node via different intermediate network nodes of the communication network. Any network node of the communication network can assume the role of source network node or destination node for data packets. The network nodes are connected together by means of connections or connection paths or links. At least one network node address, e.g. an IP address, is assigned to each of these network nodes, such as routers, switches, gateways, bridges, network elements, etc.

The network node addresses, topology information and further data are distributed via routing protocols, such as OSPF, RIP, BGP, IS-IS, etc., to the network nodes of the communication network. The information is transmitted with the aid of so-called Protocol Data Units or PDUs. As a function of the routing protocol, the PDUs contain information about their own network nodes and the adjacent network nodes linked thereto. In this manner every network node has information about the network nodes contained in the communication network and their adjacent nodes, such that any network node can or could create a network plan of the communication network therefrom. By evaluating and storing the information contained in the routing protocol PDUs or the established network view, any network node is able, on the basis of known protocols or algorithms, to calculate and store routes respectively to all the network nodes of the communication network. Routing protocols, such as OSPF and IS-IS, thereby have two main functions:

1. Protocol for identifying topology or for collating the information required for path searching.

2. Path searching and mapping the selected paths in a routing table, forwarding look-up table, forwarding information base or control table of the network node.

An algorithm for calculating routes or paths to a network node in a network is for example the shortest path search method, used in the OSPF and IS-IS routing protocols. To compensate for its limitations in respect of so-called quality of service or QoS and availability, extended path searches have also been proposed, such as multipath routing. The so-called equal cost multiple path routing method or ECMP is one type of multipath routing.

One of the available path search methods results in a better solution depending on the network topology.

The routes, paths or routing paths to a destination network node or to a destination system linked to a network node, as established by an algorithm implemented in the network node, are thereby stored in a so-called routing table, forwarding look-up table, control table or forwarding information base of the network node. This contains the network node address of the destination network node or destination system, the network node address of the adjacent network node leading to this destination and further information.

Incoming data packets with a destination network node address can be forwarded to the destination network node on the basis of the routing table. The destination network node address is thereby compared with the entries in the routing table and in the event of correspondence the adjacent network node and interface are established, via which the packet is transmitted to the destination network node.

To create its routing table or forwarding look-up table, according to which the next hop is defined for each packet for data packet forwarding, a modern router can use results from the routing information evaluated by means of the algorithm and by means of manually configured static routes.

### SUMMARY OF INVENTION

An object of the present invention is to improve the manner in which a routing path is found in a network node of a packet-switching communication network.

This object is achieved by a method and a network node with the features of the independent claims.

By using at least two or more path search methods to a network node or destination system of the communication network it is possible to combine different path search strategies, tailored in an optimum manner to the network topology, at the same time as “path search building blocks” in a network node or network. This has the advantage of allowing routing path management that is optimally tailored to the topology. Also the limitations of a generally good path search method can be compensated for by combining it with a specific path search method.

Advantageous developments of the invention are specified in the dependent claims.

Use of a multipath search method and a shortest path search method or algorithm in a network node of a communication network has the advantage that new path search strategies can be introduced in communication networks that are not fully multipath-capable. For example when a multipath routing method is introduced with a requirement of at least two disjunctive routing paths, a network may have topological restrictions, which prevent continuous multipath routing with two routes. It is then possible to combine the multipath method with the shortest path method here, while this situation continues.

### BRIEF DESCRIPTION OF THE DRAWINGS

An exemplary embodiment of the invention is illustrated in the drawing and described below. In the drawing:

FIG. 1 shows a section from a network node for the use of the claimed method.

FIG. 2 shows a variant of a network node according to FIG. 1.

### DETAILED DESCRIPTION OF INVENTION

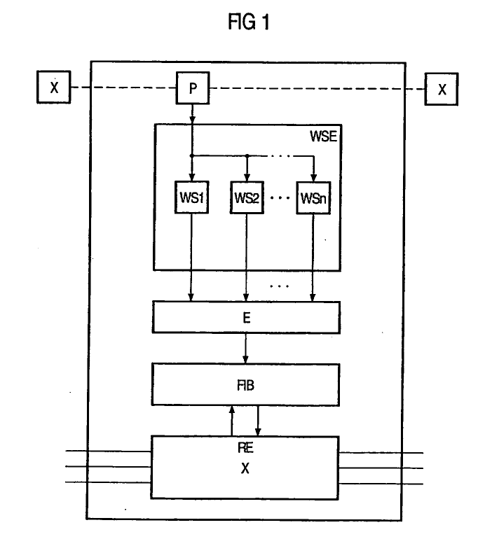

FIG. 1 shows a section from a network node, which is operated in a communication network comprising a number of network nodes. It shows a protocol evaluation arrangement P, which receives routing protocol PDUs from other network nodes and evaluates them. The protocol evaluation arrangement P feeds the received information to a path search arrangement WSE, which splits this information and feeds it to a number of path search methods WS1, . . . , WSn. The path search methods WS1, . . . , WSn each use different algorithms or take different algorithms as a basis to establish different paths to the network nodes, destination network nodes or destination systems of the communication network linked to the network nodes. For example the first path search method WS1 uses a shortest path algorithm, such as the Dijkstra algorithm, to establish the shortest path to the respective network node. The second path search method WS2 uses a multipath algorithm to establish a set of paths to a respective network node. A third path search method WS3 uses a further algorithm, such as the Bellman Ford algorithm, to establish the most economical, most fail-safe or most effective path to a network node. Further path search methods similarly establish routing paths to network nodes according to predefined basic conditions or algorithms. The routing paths established by the path search methods WS1, . . . , WSn are fed to a discriminator E, which selects one routing path to a network node respectively that is optimal for the network node in the respective network topology or satisfies corresponding criteria from the established routing paths. The selected routing path to a destination network node is fed by the discriminator E to a forwarding information base FIB or routing table or control table, which inputs it into a table or database. A routing arrangement RE forwards or routes data packets based on the forwarding information base FIB. In this process the routing arrangement RE first establishes the destination address of a received data packet. This destination address is transmitted from the routing arrangement RE to the forwarding information base FIB. The destination address is compared with stored values to establish the output or interface, port or adjacent network node, to which the packet must be sent to reach the destination address. This information is transmitted from the forwarding information base FIB to the routing arrangement RE, which then forwards the data packet to the corresponding network node.

In one embodiment of the invention the routing paths or routes established by means of the different path search methods are input jointly in the forwarding information base FIB so that a number of routes, established by means of different methods, are input in parallel in the forwarding information base FIB and are jointly active.

The path search method to be used in the respective situation can also be selected according to a wide range of criteria. This does not mean that a number of path search methods run at the same time but that a specific path search method is used for a specific network node or for a specific destination network node. Thus a suitable method for establishing routing paths can be selected based on the characteristics of the network node. Also a suitable method for establishing routing paths to a destination network node can be selected and used based on the characteristics of said destination network node.

A multipath routing method can be used in one part of the communication network and a shortest path search method can be used in another part of the communication network. Other topological criteria can also be used for the path search. Routing paths can be established by means of path search methods or corresponding algorithms according to different criteria such as cost, redundancy requirements or quality.

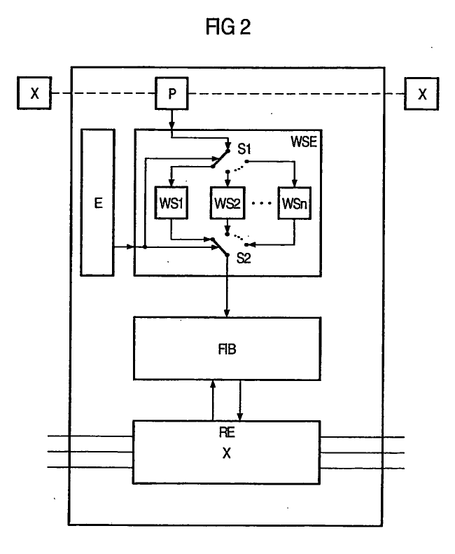

FIG. 2 shows a section from a network node according to FIG. 1, with the difference that the information fed from the protocol evaluation arrangement P to the path search arrangement WSE leads in the path search arrangement WSE via a first switching device S1 to one of a number of possible path search methods WS1, . . . , WSn. The outputs of the path search methods WS1, . . . , WSn are connected via a second switching device S2 to the input of the forwarding information base FIB. The two switching devices S1 and S2 are controlled in parallel by the discriminator E such that the information from the protocol evaluation arrangement P is fed respectively to a “selected” path search method and the routing paths established by means of the selected path search methods are fed to the forwarding information base FIB.

In this instance the automatically or manually controlled discriminator E selects one of a number of path search methods or algorithms implemented in the network node to find the routing path for the network node.

In one embodiment each network node first establishes the network structure based on the topology information exchanged between the network nodes by means of routing protocols and analyzes it. They then assign a corresponding path search method to specific destination nodes, network segments, lines or address areas according to predefined criteria. The results of the path search are then input in the forwarding information base FIB or routing table.

The discriminator for the optimum path search method can:
be controlled manually by an external management system, in that it is predefined for every network node which path search method or path search result it should use,
select a path search method automatically according to predefined features or basic conditions,
use the results of a path search according to predefined topological features or points of view,
use a specific path search method or the results of a specific path search method/algorithm for each destination network node or
select according to different criteria.

The core of the invention is that a network node can establish routing paths according to a number of path search methods or algorithms. This can be done by establishing a number of routing paths in parallel from the exchanged topology information of a routing protocol by means of a number of algorithms or path search methods. This takes place irrespective of the routing protocol used and the path search methods assigned to said protocol. This means that irrespective of the routing protocol used, e.g. OSPF, RIP, IS-IS, BGP, a number of routing paths are established according to different algorithms. Only the topology information of the routing protocol used is deployed. A discriminator controlled by means of specific criteria then establishes the routing paths suitable for the respective purpose. A number of routing paths, such as backup routing paths, can hereby also be input in the forwarding information base FIB.

A specific path search method or algorithm from a number of available methods or algorithms can also establish the routing paths to a destination network node for a network node as a function of the discriminator.

1-8. (canceled)

9. A method for path searching in a network node for a packet-switching communication network having a plurality of network nodes in which at least on of the plurality of network nodes is a destination network node, the method comprising:
exchanging information via a routing protocol;
evaluating the routing protocol information via at least two different path search methods;
selecting a path search method for each destination network node; and
storing selection results in a routing table.

10. The method according to claim 9, wherein a connection path established via the path search method and leading to a destination network node are store respectively, fed to a discriminator that selects one connection path from the set of connection paths established via the path search methods and leading to a destination network node and inputs this connection path in a table of the network node.

11. The method according to claim 9, wherein a shortest path search method is used as the path search method.

12. The method according to claim 9, wherein a multipath search method is used as the path search method.

13. The method according to claim 10, wherein the table is a routing table.

14. The method according to claim 10, wherein the table is a control table.

15. A network node for a packet-switching communications network having a plurality of network nodes in which at least one of the plurality of network nodes is a destination network node or a destination system is linked to at least one of the plurality of network nodes, comprising:
at least two different path search algorithms stored in the network node to which routing protocol information is fed; and
a routing table for storing the result of a specific path search algorithm for each destination network node.

16. The network node according to claim 15, wherein a discriminator is provided to select the results of the different path search algorithms.

17. The network node according to claim 15, wherein one of the available path search algorithms is selected by a discriminator and a resulting information is stored in the routing table.

18. The network node according to claim 15, wherein one of the available path search algorithms is selected for each destination network node or destination system and a resulting information is stored in the routing table.

19. The network node according to claim 16, wherein one of the available path search algorithms is selected for each destination network node or destination system and a resulting information is stored in the routing table.

20. The network node according to claim 17, wherein one of the available path search algorithms is selected for each destination network node or destination system and a resulting information is stored in the routing table.
